(19) United States
(12) Patent Application Publication
(10) Pub. No.: US 2020/0293590 A1
(43) Pub. Date: Sep. 17, 2020

(54) Computer-implemented Method and System for Age Classification of First Names

(71) Applicant: Kirill Rebrov, Moscow (RU)

(72) Inventor: Kirill Rebrov, Moscow (RU)

(21) Appl. No.: 16/820,650

(22) Filed: Mar. 16, 2020

Related U.S. Application Data
(60) Provisional application No. 62/819,601, filed on Mar. 17, 2019.

(51) Int. Cl. G06F 16/9536; G06N 20/00; G06F 17/18; G06F 16/906

(52) U.S. Cl. CPC G06F 16/9536; G06F 16/906; G06F 17/18; G06N 20/00

(57) ABSTRACT

A system and method that receives a list of first names as input for classifying it into age distribution classes, classifying individual records into age brackets and providing an estimate of accuracy of such classification for each list entry. Features for classifying input list into age distribution classes are engineered based on birth counts of names by year, life tables and other features. Individual list entries are then classified into age brackets using birth counts for each year, life tables and classified list's age distribution as weights. Accuracy of age bracket classification is then estimated for each entry using training data validation results similar by age and name composition.

### CROSS-REFERENCES TO RELATED APPLICATIONS

The application claims benefit of the earlier-filed US provisional patent application, application No. 62/819,601, filed on 2019 Mar. 17.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

The present invention relates to the field of computer science, and, more specifically, to the field of machine learning.

Today, 90.7% of US marketers use customer segmentation in their marketing campaigns¹. Customer segmentation is breaking customer list into smaller segments. These segments can be made in different ways: by age, by gender, etc. For example business can target women and men or Millennials and Baby Boomers separately delivering more relevant offers to each group (segment). According to MailChimp, segmented email campaigns produce 100.95% higher click² rate. ¹ www.emarketer.com/Article/How-Data-Driving-Marketing/1013450² mailchimp.com/resources/effects-of-list-segmentation-on-email-marketing-stats/

However there is a problem with customer segmentation. Before segmenting customers, their consumer data should be obtained. Existing solutions for obtaining additional data about consumers suffer from several fundamental problems: low coverage for input list, unknown accuracy and compromised privacy of the list.

One of the techniques to obtain data involves manual collecting consumer data via surveys or open sources which is inefficient due to high time and money costs and low coverage because of low response rate and little information available in open sources. For example, an average response rate for a survey is 10-20%³. Alternative is using so called data brokers or data append services, services that resell private information from consumer databases. In order to get additional consumer data about its customers, the company is required to provide data broker with customers' sensitive information. The more sensitive information is provided the higher probability to get additional data. Example. If company A wants income level and gender of its customer it should provide company B with address, phone, email or other personally identifiable information of this customer in order for B to obtain a record of this customer in their database or database(s) of its partner(s). It's a big and growing market reaching $26B in spendings on consumer data globally in 2019⁴ with 73.8% of marketers say they purchase third-party consumer data for their marketing⁵. ³ knowledgebase.constantcontact.com/articles/KnowledgeBase/5509-predict-survey-response-rates?lang=en_US⁴ www.onaudience.com/files/OnAudience.com_Global_Data_Market_Size_2017-2019.pdf⁵ www.emarketer.com/Article/How-Data-Driving-Marketing/1013450

But the source and, as a result, accuracy of obtained third-party data is generally unknown. It can be purchased from another data broker or collected using controversial or illicit methods like the ones used in the Facebook/Cambridge Analytica case. You never know where the data comes from. One of the problems with such services is low coverage and questionable accuracy since sources are unknown and information is often incomplete and outdated. For example, the most accurate match input attribute for record linkage solutions is postal address. However, this is an imperfect attribute since only 66.9% of mail is deliverable as addressed according to NCOA⁶ and 10.1% of Americans move annually according to mobility data of the US Census Bureau⁷. ⁶ www.nationalchangeofaddress.com/FAQs.html⁷ www.moving.com/tips/us-moving-statistics-for-2019/

The coverage is also low because it depends on how much input data is provided to identify the person. Some list holders are not willing or not allowed due to privacy policy and concerns to share sensitive information with third-parties thus being prevented from using data append services. Others simply don't possess necessary information about part of their list or the whole list. According to own analysis of most popular data append services less than 30% of provided data can be appended on average (depending on data field).

Another even bigger problem is that the increasing sharing and selling of personally identifiable information of consumers contributes to the growing privacy concerns and data leaks. For example, according to Javelin in 2017 total identity fraud victims reached 16.7 millions in the US, a record high⁸. Another example is Acxiom, industry leader in data brokerage. Largest data breach in history occurred in 2003 when more than 1.6 billion customer records were stolen during the transmission of data to and from Acxiom's clients⁹. ⁸ www.javelinstrategy.com/press-release/identity-fraud-hits-all-time-high-167-million-us-victims-2017-according-new-javelin⁹ en.wikipedia.org/wiki/LiveRamp

The latter problem is especially serious because the data marketing landscape is changing. Personal data regulation is increasing and privacy concerns are growing. For example, 84% of consumers are concerned about security of their personal information according to the International Data Corporation (IDC). While 78% are ready to switch to a different business if there is any threat to their personal data (source: IDC)¹⁰. Data regulation is increasing too. EU introduced its General Data Protection Regulation (GDPR) which becomes enforceable starting May 25, 2018. According to GDPR all data processing and use should be opt-in, and consumer consent for data use should be clear. In general it completely prohibits current data marketing based on third-party non opt-in personal data within EU and for any company that uses, at least in part, personal data of EU residents. In other worlds privacy-enabled solutions for data marketing are in high demand and this demand is anticipated to be increased due to data regulation prospects. ¹⁰ www.businesswire.com/news/home/20170124005189/en/New-IDC-Survey-Finds-Widespread-Privacy-concerns

Another two existing technologies to extract age information not involving data brokers or data append services include face recognition and detecting age based on person's interests and activities in the Internet or, in most cases and particularly, in social media. The former approach involves supervised learning machine learning algorithms to classify age using facial features. The latter approach also uses supervised learning machine learning algorithms to classify age using person's interests or other person characteristics as features. This information is normally obtained using third-party cookies or other tracking technologies to collect websites visited by the person and/or information entered or read by the person on these websites. Though both approaches have promising and efficient implementations demonstrating high accuracy and efficiency, both of them have drawbacks in terms of coverage and privacy.

Face recognition software requires biometric information as both input and training data. Facial biometric information is widely considered PII (personally identifiable information) and therefore is subject to personal data regulation with implications similar to the ones involving data brokers and data append service. Besides that appropriate person photos suited for face recognition tasks is a rare and scarce data unavailable to most businesses. As a result, it makes this approach is not widely used and privacy safe.

Tracking a person's behavior is also a subject to both privacy concerns and low coverage due to the long term efforts and resources required for tracking reasonably large groups of people online. Such technologies are only used by large advertising and technology companies in their products and generally don't provide individual information limiting extracted data to mostly aggregated anonymous information.

As a result, there is still a lack of technology for extracting age information that can be both used widely by any business or other entity with even incomplete and anonymized lists of persons and address privacy by being compliant with privacy data regulations.

### BRIEF SUMMARY OF THE INVENTION

The present invention addresses the problems described in the “BACKGROUND OF THE INVENTION” section for age demographics extraction. It addresses: low coverage, unpredictable accuracy and, which is most important, privacy. Thus the solution provides full coverage age extraction, predictable and manageable accuracy (user can choose the balance between coverage and predicted accuracy) and complete privacy. The latter advantage enables the solution to be used in GDPR-affected markets as well as markets affected by other present and future private data regulations which is a vital advantage over traditional data brokers and data append services.

The solution provides a method and system of classifying list of first names into defined age brackets. Last names can be masked or even omitted. Thus no PII (personally identifiable information) is required in the process. For example, Michael J*son which can be either Jameson, Johnson, Jackson and so on. Such a solution implements a so called trustless system. A trustless system is one that does not depend upon the intentions of its participants who may be honorable or malicious. The system functions in the same manner regardless of the intentions of its parties. For example, blockchain, with a peer-to-peer protocol that is also transparent and immutable, is trustless. In the same way customer segmentation without the need of providing PII (personally identifiable information) is trustless as no data leak is possible by design since no sensitive data is shared at all. Such a solution is also called privacy by design. Privacy by design is not about data protection but designing so data doesn't need protection. More specifically, an aspect of the present invention is to provide a method and system for training the model for age distribution classification of the list of persons containing only first names using supervised machine learning.

Another aspect of the present invention is to provide a method and system for a privacy-enabled process of classifying age distribution of the list of persons containing only first names using supervised machine learning.

Another aspect of the present invention is to provide a method and system for a privacy-enabled process of classifying the list of persons containing only first names into age bracket demographic data based on supervised machine learning.

Another aspect of the present invention is to provide a method and system for predicting expected accuracy of classifying list of first names into age bracket demographic data mentioned in the third aspect of the present invention.

### BRIEF DESCRIPTION OF DRAWINGS

Reference will be made to the accompanying drawings, which are not necessarily drawn to scale, and wherein:

FIG. 1 is an overview of claim 1 of the present invention. The drawing depicts the process of training model for age distribution classification.

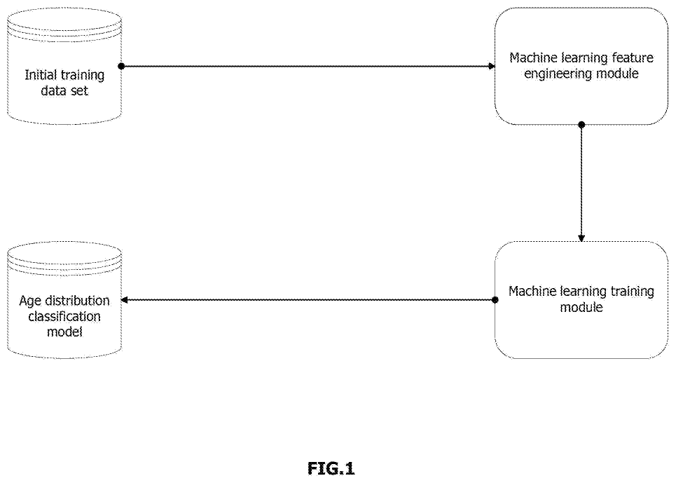

FIG. 2 is an overview of claim 2 of the present invention. The drawing depicts the process of classifying list of first names into age distribution classes using previously trained age distribution classification model.

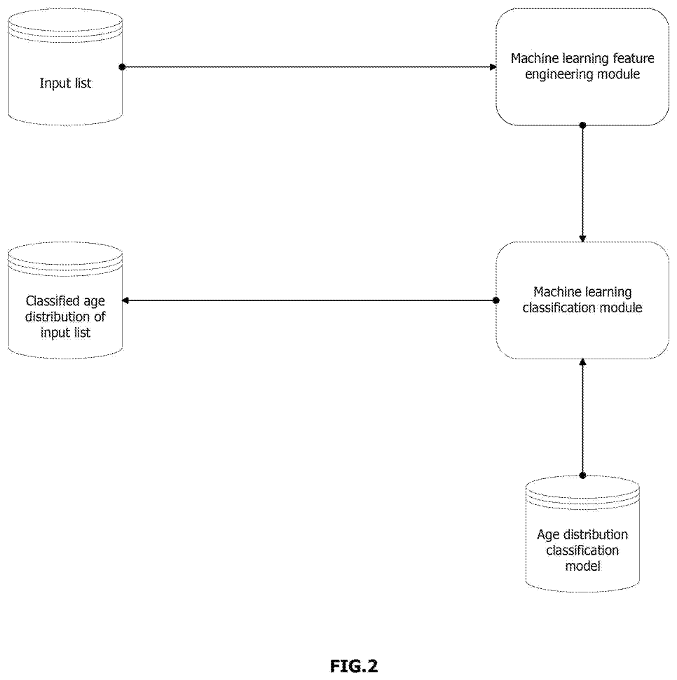

FIG. 3 is an overview of claim 3 of the present invention. The drawing depicts the process of classifying list entries into defined age brackets using previously classified age distribution of the list as input data for classification.

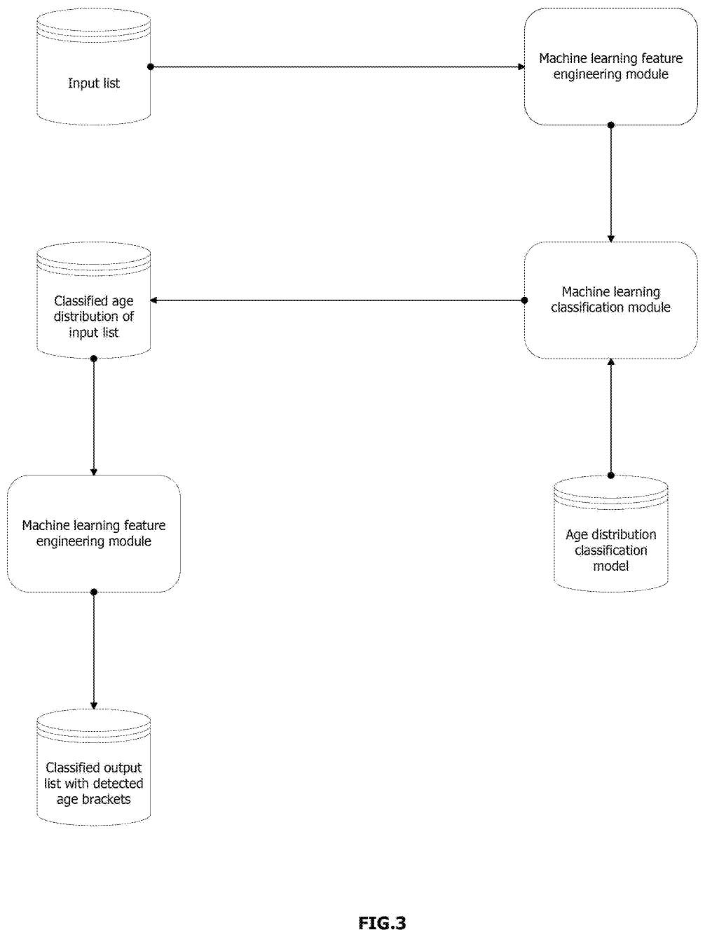

### DETAILED DESCRIPTION OF THE INVENTION

The present invention provides a method and system for a privacy-enabled process of classifying list of first names into age distribution classes, classifying individual list entries into defined age brackets and predicting its classification accuracy. The algorithm is based on supervised machine learning. The disclosure below provides detailed description of the various parts of the claimed method and system.

A number of terms are used in this disclosure. The following definitions are provided to explain the meaning of these terms.

The term platform refers to a group of software modules and storage mediums that implement the system and method disclosed in the present invention,

The term software module refers to one or more software algorithms separated logically from other software algorithms in the proposed method of the present invention.

The term storage medium refers to both in-memory, disk, databases or any other storage mediums and mechanisms that persist data required by software modules permanently or temporarily. It should be noted that the scope of the present invention covers both permanent (e.g. disk or database) and temporary (e.g. in-memory) storages.

The term input list refers to a list containing at least first name for each list entry with last name that can be partially masked or omitted completely hiding identities of list entries.

The term list owner refers to any entity operating input list or lists within the platform.

The term machine learning feature engineering module refers to a set of storage mediums and software algorithms. It is used to create features from raw training data set for subsequent training by machine learning training module, classifying by machine learning classification module, as well as classifying intermediate list to get output list at the final phase of detecting age brackets.

The term intermediate list refers to the processed input list with appended calculated predicted age for each entry. Intermediate list is processed by the machine learning feature engineering module during the initial steps of the proposed method and system.

The term output list refers to the processed intermediate list with appended weighted predicted age and classified age brackets.

The term list entry refers to a record in a list.

The term names birth data refers to any data set containing information about the number of people with a respected name born in a given year or with a given age. The minimal information contained in this data is name and year of birth or age. If data is aggregated by name then number of births for each name and birth year or age is also required. The data can optionally contain additional information to narrow down to a particular population, geographical area, gender, occupation of person born or any other criteria. It should be noted that birth data can be represented in both birth years and ages.

The term life table refers to a data set which shows, for each age or birth year, the probability that a person of that age will die before his or her next birthday. The data can optionally contain additional information to narrow down to a particular population, geographical area, gender, occupation of person born or any other criteria. Alternatively, after respective processing, it represents the survival rate of people for a certain birth year. This information is used to adjust birth data information in order to more precisely evaluate the probability that a particular person with a particular name born in a particular year is still alive.

The term predicted age refers to either weighted arithmetic mean or median age calculated using birth data and survival rates from life tables.

The term known age refers to the initially known age of input list entry in training data set.

The term age bracket refers to one of the defined age groups into which the list is splitted. The age bracket is defined by minimum and maximum age of each list entry belonging to this age bracket. The maximum age can be omitted meaning that list entry belongs to this age bracket if its age is greater than or equal to minimum age of the age bracket. The minimum age can also be omitted meaning that list entry belongs to this age bracket if its age is less than or equal to maximum age of the age bracket. It should be noted that the special case of age bracket in the present invention is the age bracket with minimum age equal to maximum age of the bracket meaning that age bracket can discretely represent age of the person. In such a scenario the task of classifying list entries into age brackets becomes the task of predicting age for list entry.

The term age distribution refers to the age distribution or composition of the list according to defined age brackets. Age distribution consists of either aggregated counts of list entries belonging to each age bracket or relative share of list entries belonging to each age bracket.

The term age distribution class refers to class label or category coded from age distribution. For example it can be, but not limited to, a string or numeric representation of the list's particular age distribution. E.g. “0.60, 0.30, 0.10” age distribution class can represent age distribution of three age groups with respective shares of 60%, 30% and 10%. It should be noted that the actual class label can contain any sequence of characters containing age distribution information.

The term weights refers to adjustment made to probabilities that list entry belongs to a certain age bracket. Weights increase or decrease influence made by the respective age bracket on the result of calculation. Higher weight of the age bracket increases the probability that list entry belongs to this age bracket. During calculation of the predicted age, births in each year that are in a certain age bracket additionally adjusted by respective relative share of this age bracket. This results in a different predicted age since predicted age is calculated as weighted arithmetic mean or median using aforementioned weights.

The term initial training data set refers to a training data set which is used by machine learning feature engineering module to transform features for further processing. The data set contains at least a first name and known age for each entry.

The term age distribution classification model refers to a machine learning model which is trained by a machine learning training module using a processed training data set. The model is being used by a machine learning training module for classifying input list into age distribution classes. It should be noted that the scope of the present invention covers both training and classification of the model as separate processes since training can be performed at any time prior to classification step of age distribution. It also should be noted that the method of classifying input list into age distribution classes is independently claimed and relies on a trained age distribution classification model as a prerequisite.

The term machine learning training module refers to a set of storage mediums and software algorithms. It is used to train age distribution classification model using features engineered by machine learning feature engineering module. It should be noted that the scope of the present invention doesn't restrict machine learning classification algorithms used for training and classifying age distribution. Any supervised learning classification algorithm including but not limited to Naïve Bayes, Logistic Regression, Decision Tree, Random Forest, Support Vector Machine, etc can be used depending on data and other factors. The novelty of the present invention is not in using a particular machine learning classification algorithm but in feature engineering and processing data to prepare efficient input variables for training and classifying input list into age distribution classes as a crucial step in both extracting aggregated age distribution data and further classifying individual list entries into defined age brackets.

The term machine learning classification module refers to a set of storage mediums and software algorithms. It is used to classify lists into age distribution classes. Classification can be performed by any supervised learning classification algorithm.

The term machine learning validation module refers to a set of storage mediums and software algorithms. It is used to predict expected accuracy of classifying list entries into defined age brackets. It predicts expected accuracy for each list entry thus potentially allowing list owner to select only a subset of list entries with higher accuracy and exclude list entries with lower predicted accuracy if it doesn't meet defined data quality thresholds.

The term classification accuracy dataset refers to the data stored in storage medium that is compiled by machine learning validation module during evaluation of classification accuracy on subsets of data from initial training dataset sampled by different age distributions. It contains information about name, age distribution the name occurred in and information about accuracy of classifying the name based on a number of correct classifications and number of wrong classifications.

The platform consists of software modules and storage mediums. The platform is designed for usage by list owners.

Machine learning training module can train age distribution classification model both as the initial step of the proposed method and during any further steps of the proposed method before the step of classifying input list into age distribution classes. The initial training data set contains a diversified list of at least first name and birth year or age for each list entry. Machine learning feature engineering module extracts subsets of different age distributions from the initial training data set randomly creating sublists comprising different age distributions to cover all possible combinations of age brackets' shares having multiple samples of each combination of shares. Then machine learning feature engineering module engineers at least the following features for each sublist: calculated age distribution data for each defined age bracket based on predicted age for each list entry by machine learning feature engineering module.

The calculation of age distribution features is performed in several steps. First, the predicted age for each list entry is calculated using a machine learning feature engineering module by loading birth data for each name in the list and adjusting it by survival rates from life tables in order to get an intermediate representation of birth statistics for each birth year and name. Then weighted arithmetic mean or median is applied on a set of different ages transformed from birth years as difference between current year and birth year with birth counts adjusted by survival rates as weights. It should be noted that the scope of the present invention isn't limited to using arithmetic mean or median. Any other weighted function returning average value can be used.

Actual age distribution for each sublist is used as class labels in the training data coded from actual age distribution information. Each class label contains information about the shares of each defined age bracket. E.g. “0.60, 0.30, 0.10” age distribution class can represent age distribution of three age groups with respective shares of 60%, 30% and 10%. It should be noted that the actual class label can contain any sequence of characters containing age distribution information. Predicted and actual age distributions are calculated by counting list entries in each age bracket and dividing them by the total number of list entries. Actual age distributions are used as class labels and predicted age distributions are used as features. The result is a processed training data set which is then used by a machine learning training module to train age distribution classification model,

List owner provides input list for further processing by machine learning feature engineering module. Machine learning feature engineering module uses names' birth data and life tables for each name in the list to calculate predicted age for each input list entry in the list. As in the training phase; the predicted age for each list entry is calculated using a machine learning feature engineering module by loading birth data for each name in the list and adjusting it by survival rates from life tables in order to get an intermediate representation of birth statistics for each birth year and name. Then weighted arithmetic mean or median is applied on a set of different ages transformed from birth years as difference between current year and birth year with birth counts adjusted by survival rates as weights. It should be noted that the scope of the present invention isn't limited to using arithmetic mean or median. Any other weighted function returning average value can be used.

After calculating predicted ages for each input list entry by machine learning feature engineering module and creating intermediate list, machine learning feature engineering module calculates age distribution of the intermediate list by counting intermediate list entries in each age bracket and dividing them by the total number of list entries. The resulting data is predicted age distribution for each defined age bracket based on predicted age of each entry.

Calculated age distribution data for each defined age bracket is then used as input variables for a machine learning classification module which uses the age distribution classification model trained previously. The result of classification is detected class label or category containing information about age distribution of the list.

To classify each list entry into defined age brackets, age distribution from predicted age distribution class is then used as weights for processing intermediate list by machine learning feature engineering module. This processing includes applying age distribution data for each defined age bracket as weights during second calculation of predicted age for each list entry in the list in which previously predicted age is additionally adjusted to the shares of corresponding age bracket calculated from classified age distribution. During this process predicted age, which was previously calculated using birth counts for each name and birth year from names birth data and survival rates calculated from life tables, then multiplied by relative share of respective age bracket birth year or age belongs to. Then predicted age for each list entry is updated and age bracket is appended to each list entry if predicted age belongs to this age bracket.

Additionally, accuracy of age classification proposed in the present invention can be evaluated and predicted in advance. For this purpose, machine learning validation module extracts subsets of different age distributions from the initial training data set randomly creating sublists of different age distributions to cover all possible combinations of age brackets' shares having multiple samples of each combination of shares. These subsets are then processed through all steps of the proposed method required to classify each list entry into age brackets. The results of classification are then evaluated by a machine learning validation module, which counts the number of correctly and incorrectly classified names for each sublist using known age. It should be noted that any function measuring accuracy can be utilized and the scope of the present invention. Then, the machine learning validation module compiles a classification accuracy dataset. The dataset consists of name, age distribution name occurred in, accuracy information for this name based on the number of wrong classifications for this name and the number of correct classifications for this name. It should be noted that the scope of the present invention doesn't restrict whether this classification accuracy dataset is stored in-memory or permanently (e.g. disk or database). The particular data structure is also not restricted. The minimum information that should be present is name, age distribution of sub list the name is evaluated in and estimated accuracy.

Then the list owner provides an input list containing at least first names. Machine learning validation module processes the list through all steps of the proposed method required to classify input into age distribution labels. Using age distribution data from classified age distribution labels and names from input list estimated classification accuracy for each name in the input list is calculated using classified and evaluated subsets with similar age distribution and names. In order to retrieve expected accuracy for each name in the list the nearest entry in classification accuracy dataset is selected by comparing classified input list's age distribution and entry's age distribution from classification accuracy dataset. Any comparison function can be used in the scope of the present invention. The average predicted list classification accuracy can be estimated as average accuracy of all list entries.

Because of the availability of predicted accuracy information for each list entry, the proposed method of the present invention also allows list owner to choose a balance between predicted accuracy and coverage of input list. For this purpose, list can be sorted by predicted accuracy allowing to choose only list entries with higher accuracy to meet data quality thresholds if any.

1. A computer-implemented method for training model for age distribution classification of list of first names; the method comprising:
(a) extracting, by a machine learning feature engineering module, subsets comprised of different age distributions from the initial training data set of people with known ages to cover all possible combinations of defined age brackets' shares having one or more samples of each combination of shares;
(b) calculating, by a machine learning feature engineering module, predicted age for each list entry in each extracted subset by
(i) calculating number of births for each year of each name in the list using number of births from names birth data for a given first name and year and adjusted by survival rate for a given year calculated from life tables; and
(ii) calculating predicted age for each list entry by calculating weighted arithmetic mean or median age using number of births for each age (age is calculated as difference between current year and birth year), calculated in (i), as weights;
(c) engineering, by a machine learning feature engineering module, the features of each subset by calculating estimated age distribution of the subset by dividing number of list entries in each defined age bracket by total number of all list entries using predicted age calculated at step (b);
(d) training, by a machine learning training module, each extracted subset with engineered features as input variables and actual age distribution coded from age distribution information into class labels of the training data set using one of the machine learning supervised learning classification algorithms;

2. A computer-implemented method for classifying list of first names into age distribution classes; the method comprising:
(a) receiving, by a machine learning feature engineering module, an input list containing at least first names;
(b) calculating, by a machine learning feature engineering module, predicted age for each input list entry by
(i) calculating number of births for each year of each name in the list using number of births from names birth data for a given first name and year and adjusted by survival rate for a given year calculated from life tables; and
(ii) calculating predicted age for each list entry by calculating weighted arithmetic mean or median age using previously calculated number of births for each age (age is calculated as difference between current year and birth year) as weights;
(c) engineering, by a machine learning feature engineering module, the features of input list by calculating estimated age distribution of the list by dividing number of list entries in each defined age bracket by total number of all list entries using predicted age calculated at step (b); and
(d) classifying, by a machine learning classification module, input list into age distribution classes using one of the machine learning supervised learning classification algorithms on age distribution classification model previously trained using same engineered features extracted from initial training data set.

3. A computer-implemented method for classifying list entries into defined age brackets; the method defined in claim 2 further comprising:
(a) multiplying, by a machine learning feature engineering module, number of births for each year of each name, calculated in step (b)(i) of claim 2, by the share of corresponding age bracket in age distribution classified in step (d) of claim 2; and
(b) calculating, by a machine learning feature engineering module, predicted age for each list entry by calculating weighted arithmetic mean or median age using number of births for each previously calculated age (age is calculated as difference between current year and birth year) as weights.

4. A computer-implemented method, depending on steps in claim 3; for predicting accuracy of classifying first names into defined age brackets; the method comprising:
(a) extracting, by a machine learning validation module, subsets of different age distributions from the initial training data set to cover all possible combinations of age brackets' shares having multiple samples of each combination of shares;
(b) classifying; by a machine learning classification module, each subset through all steps defined in claim 3;
(c) calculating, by a machine learning validation module, classification accuracy by evaluating results of the classification for each subset;
(d) classifying; by a machine learning classification module, input list, which classification accuracy is being evaluated, through all steps defined in claim 3; and
(e) retrieving; by a machine learning validation module, estimated classification accuracy for each name in the input list and for the whole input list as average accuracy of all names from classified and evaluated subsets with similar age distribution and names.

5. A computer-implemented system for classifying age distribution of list of first names; the system comprising of one or more software modules:
(a) a machine learning feature engineering module programmed to:
(i) calculating predicted age for each list entry in each subset extracted from training data by
calculating number of births for each year of each name in the list using number of births from names birth data for a given first name and year and adjusted by survival rate for a given year calculated from life tables; and
calculating predicted age for each list entry by calculating weighted arithmetic mean or median age using number of births for each age (age is calculated as difference between current year and birth year) as weights;
(ii) receiving input list containing at least first names;
(iii) calculating predicted age for each input list entry by
calculating number of births for each year of each name in the list using number of births from names birth data for a given first name and year and adjusted by survival rate for a given year calculated from life tables; and
calculating predicted age for each list entry by calculating weighted arithmetic mean or median age using previously calculated number of births for each age (age is calculated as difference between current year and birth year) as weights;
(iv) calculating predicted age for each input list entry by
calculating number of births for each year of each name in the list using a number of births received from names birth data for a given first name and year and adjusted by survival rate for a given year calculated from life tables; and
calculating predicted age for each list entry by calculating weighted arithmetic mean or median age using previously calculated number of births for each age (age is calculated as difference between current year and birth year) as weights;
(v) extracting, from the initial training data set of people with known ages, subsets comprised of different age distributions to cover all possible combinations of age brackets' shares having one or more samples of each combination of shares;
(vi) engineering the features from each subset from training data by calculating estimated age distribution of the subset by dividing number of list entries in each defined age bracket by total number of all list entries using calculated predicted age;
(vii) engineering the features from input list by calculating estimated age distribution of the list by dividing number of list entries in each defined age bracket by total number of all list entries using calculated predicted age;
(b) a machine learning training module programmed to:
(i) training each extracted subset from training data with features engineered by machine learning feature engineering module as input variables and actual age distribution coded from age distribution information into class labels utilizing one of the machine learning supervised learning classification algorithms;
(c) a machine learning classification module programmed to:
(i) classifying input list into age distribution classes using one of the machine learning supervised learning classification algorithms on training data previously trained using the same engineered features.

6. A computer-implemented system for classifying first names into defined age brackets and predicting accuracy of age bracket classification; the system comprising of one or more software modules defined in claim 5, further extended:
(a) a machine learning feature engineering module programmed to:
(i) calculating number of births for each year of each name in input list using number of births from names birth data for a given first name and year adjusted by survival rate for a given year calculated from life tables;
(ii) multiplying calculated number of births for each year of each name by share of corresponding age bracket in classified age distribution of input list;
(iii) calculating predicted age for each input list entry by calculating weighted arithmetic mean or median age using number of births for each age (age is calculated as difference between current year and birth year) as weights;
(b) a machine learning validation module programmed to:
(i) extracting subsets of different age distributions from the initial training data set to cover all possible combinations of age brackets' shares having multiple samples of each combination of shares;
(ii) calculating classification accuracy by evaluating results of the classification for each subset;
(iii) retrieving estimated classification accuracy for each name in the input list and for the whole input list as average accuracy of all names from classified and evaluated subsets with similar age distribution and names.
